(19) United States
(12) Patent Application Publication
(10) Pub. No.: US 2006/0149523 A1
(43) Pub. Date: Jul. 6, 2006

(54) Software for die-stamping modelling

(76) Inventors: Faycal Mehrez, Paris (FR); Fouad El Khaldi, Mennecy (FR); Christian Ahouangonou, Montfermeil (FR); Pierre Viossat, Puyricard (FR); Caroline Borot, Gardanne (FR)

Correspondence Address: BACHMAN & LAPOINTE, P.C., 900 CHAPEL STREET, SUITE 1201, NEW HAVEN, CT, 06510, US

(21) Appl. No.: 10/537,367

(22) PCT Filed: Dec. 2, 2003
(86) PCT No.: PCT/FR03/03564

§ 371 Date: Jan. 16, 2006

(30) Foreign Application Priority Data
Dec. 2, 2002 (FR) 02/15157

(51) Int. Cl. G06G 7/58; G06G 7/48

(52) U.S. Cl. 703/12

(57) ABSTRACT

The invention concerns a method for digital simulation of a die-stamping process comprising the following steps: recording at least one metamodel consisting of a permanent collection of the digital representations of elementary components of die-stamping tools, each of the elementary components being defined in the form of finished elements, and comprising digital static attributes; recording a digital model for deforming a blank used in the process to be simulated; selecting a subassembly of the permanent collection, by temporarily recording the elementary components representing a particular die-stamping tool corresponding to the simulation concerned, the subassembly constituting a specific collection in the form of digitized finished elements of the specific collection, parameterizing said digitized finished elements of the specific collection, and the corresponding attributes based on the characteristics of the process to be simulated; recording the digital data representing the relative movements of the components of the specific collection, based on operating cycles of the die-stamping process to be simulated; recalculating the digital models for deforming the blank based on the recorded digitized data in the parameterized specific collection, of the digital model of the blank, and of the specific displacements; generating a digital or visual representation of deformations of the blank by applying the recalculated digital model.

### BACKGROUND OF THE INVENTION

(1) Field of the Invention

The present invention relates to the field of software for simulating physical phenomena.

The present invention relates more particularly to software for simulating pressing.

(2) Prior Art

The prior art already knows, through the American patent application U.S. Pat. No. 5,379,227 (Ford Motor), a method and system for evaluating sheet metal forming tooling design, for use with a draw die including a punch and binder designed to form the sheet metal into a part, utilizing improved implicit time integration methods that reduce numerical instability, thereby enhancing convergence of numerical solutions. The sheet metal and tool surface of the punch are each represented as a mesh having a plurality of nodes. Contact nodes between the sheet metal mesh nodes and the tool surface mesh can be identified. A first embodiment includes minimizing discontinuities generated by unloading by determining a stress increment of a sampling point in the sheet metal mesh according to an incremental deformation theory of plasticity. A second embodiment includes modelling a draw-bead as a plurality of nonlinear elastic springs to minimize discontinuities in the spring force during unloading. A third embodiment includes filtering a relative velocity vector of at least one contact node with respect to the tool surface, to avoid frictional force oscillations due to the change in direction of the relative velocity vector during formation of the part.

The prior art also knows, through the American patent application U.S. Pat. No. 5,552,995 (The Trustees of the Stevens Institute of Technology), a computer-based engineering design system to design a part, a tool to make the part, and the process to make the part. The design system has a processor and a memory. The memory stores feature templates, each feature template being a representation of a primitive object having a form and a function. Each feature template is indexed by the function of the primitive object and includes a representation of a primitive geometric entity having the form of the primitive object. Each feature template can include information relating to a tool to make the primitive object and a process to make the primitive object. The design system also includes an input device for receiving a request to design the part. This request includes one or more predetermined functions that the part performs. A core design module, executable by the processor, designs the part, the tool to make the part and process to make the part by accessing the plurality of feature templates in the memory to locate one or more primitive objects that perform the one or more predetermined functions.

The prior art also knows, through the American patent application U.S. Pat. No. 6,219,055 (SolidWorks), a computer-based forming tool. A forming tool is provided for manipulating a computer model, including mechanisms for allowing a user to define a forming tool for creating a form feature of the model. Characteristics of the forming tool may be defined so that the forming tool may be reused without the need to redefine its characteristics.

The prior art also knows a solution for the design of a fabrication method comprising steps of representing a workpiece as a plurality of triangular finite elements, representing pressing tools with mathematical equations which typically comprise cubic polynomials, simulating deformation of the workpiece by the pressing tools with a finite-element model, the finite-element model being integrated explicitly. The method can be implemented by an apparatus which comprises a memory device storing a program comprising computer-readable instructions, and a processor that executes the instructions. After the deformation of the workpiece has been simulated by the finite-element model, the characteristics of the workpiece and of the pressing tools can be modified in order to improve the final form of the worpiece. After the simulation by finite elements has produced an acceptable final workpiece form, an actual workpiece can be pressed with real tools based on the simulation.

The pressing simulation software of the prior art has the drawback of in some cases being limited with regard to the possibility of finely defining the type of pressing process, and in other cases, more parameterisable, the drawbacks seen from the point of view of the final user, being lengthy and complex to implement having regard to the magnitude of the parameterising.

### SUMMARY OF THE INVENTION

The present invention intends to remedy the drawbacks of the prior art by proposing a system which enables the user to define his own pressing process models and which enables this same user or another, once a pressing process has been defined, no longer to have to carry out anything but a limited number of parameterisings for the pressing process model in question. Meta-models are defined for generating dialogues dedicated to the specific press of a given user.

To this end, the invention concerns, in its most general acceptance, a numerical simulation method for a pressing process comprising the steps consisting of:
recording at least one meta-model consisting of a permanent collection of numerical representations of the elementary constituents of pressing tools, each of the said elementary constituents being defined in the form of finite elements, and comprising numerical static attributes,
recording a numerical model of deformation of a blank used in the process to be simulated,
selecting a subset of the said permanent collection, for temporary recording of elementary constituents representing a particular pressing tool corresponding to the simulation in question, the said subset constituting a specific collection in the form of digitised finite elements,
parameterising the said digitised finite elements of the specific collection, as well as the corresponding attributes according to the characteristics of the process to be simulated,
recording numerical information representing the relative movements of the components of the said specific collection, according to the operating cycles of the pressing process to be simulated,
recalculating the numerical models of deformation of the blank according to the numerical information recorded on the one hand in the parameterised specific collection, the numerical model of the blank, and the specific movements on the other hand,
generating a numerical or visual representation of the deformations of the blank by the application of the said recalculated numerical model.

The selection step preferably modifies the state of the elementary constituents that are not pertinent with regard to the constituents selected.

Advantageously, the method comprises a step of loading at least part of the parameterising information of the collection from an external information medium.

According to a particular embodiment, the method comprises a step of loading the model of the blank from an external information medium.

According to a variant, the method comprises a step of loading the numerical representation of the said sub-set from an external information medium.

According to another variant, the step of making up the specific collection is implemented by the display of a graphical interface and the recording of the information entered from the said graphical interface.

Preferably, the step of displaying a graphical interface comprises an operation of personalising a prerecorded interface, this personalisation taking account at least partly of the information coming from the prior steps of the method.

Advantageously, several levels of use are defined, one of the levels of use, supervision, requiring a common generic parameterising defining to a great extent the pressing method concerned and the other, basic, levels of use, requiring no more than a partial parameterising, complementary and specific, benefiting from the previously performed parameterising of the supervision level.

### BRIEF DESCRIPTION OF THE DRAWINGS

The invention will be better understood with the help of the description, given below purely by way of explanation, of one embodiment of the invention, with reference to the accompanying figures:

FIG. 1 depicts the performance of the method according to the invention;

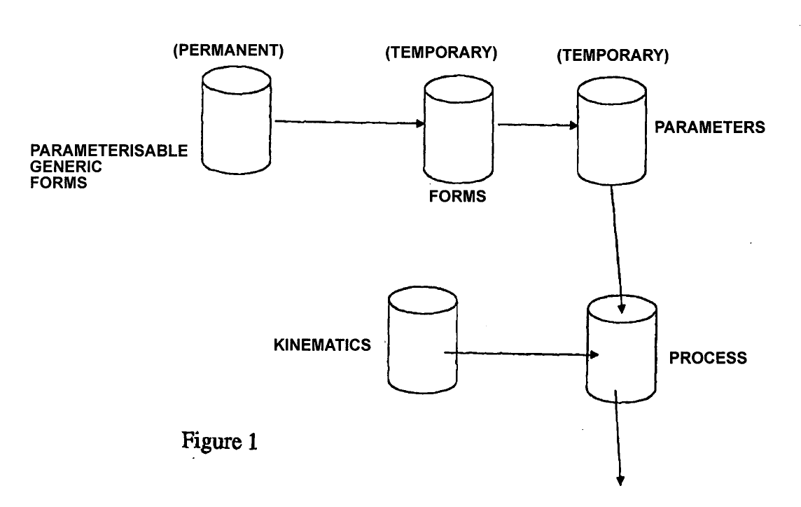

FIG. 2 depicts the formation and processing of the meta-model in the form of a computer file;

FIG. 3 depicts the application as seen by the supervisor;

FIG. 4 depicts the application as seen by the final user.

### DETAILED DESCRIPTION OF THE PREFERRED EMBODIMENT(S)

The term “pressing process” includes the tools and the characteristics. Moreover, “attribute” means a physical and numerical characteristic. The deformation is often referred to as “forming” by persons skilled in the art.

The term “project” covers the complete computer file comprising all the data having to be processed by the “solver”, the result of this latter processing constituting the complete simulation.

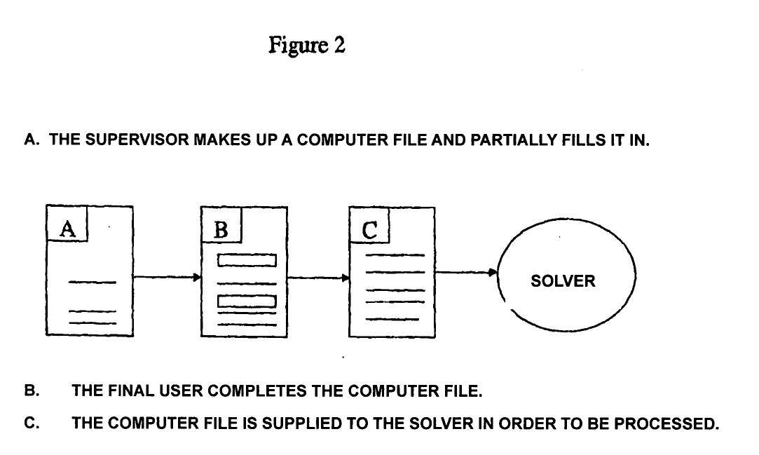

The meta-model has the structure of a computer file, which constitutes a major part of the project. As described in FIG. 2, this meta-model is formed by the supervisor, and the latter therefore partially fills in the project and leaves fields that the final user will give information on by means of a graphical interface. The set consisting of the meta-model and the data added by the final user, thus constituting a complete project, is thus created and will be processed by the “solver”. The supervisor chooses whether or not he must leave the final user to fill in a given parameter. Where a parameter is requested of the final user, a default value for this parameter is often supplied by the supervisor.

The aim of the invention is to enable the users to define themselves the major part of the pressing modelling process. The concept of macrocommands is divided into two distinct steps:
defining the macrocommands in accordance with the requirements of the process (carried out by the supervisor)
applying the macrocommands by giving information on a restricted number of parameters (performed by the final user).

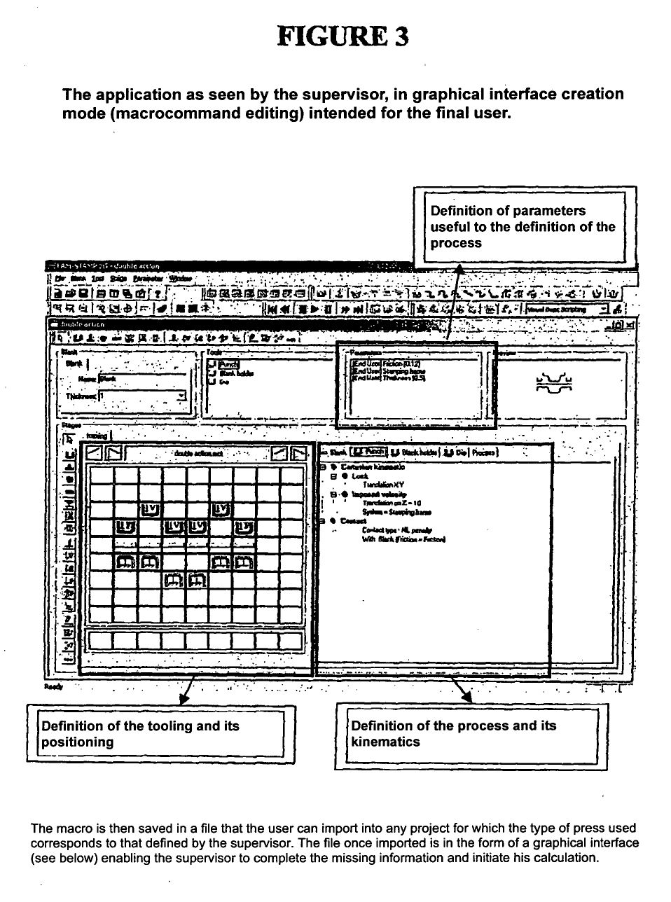

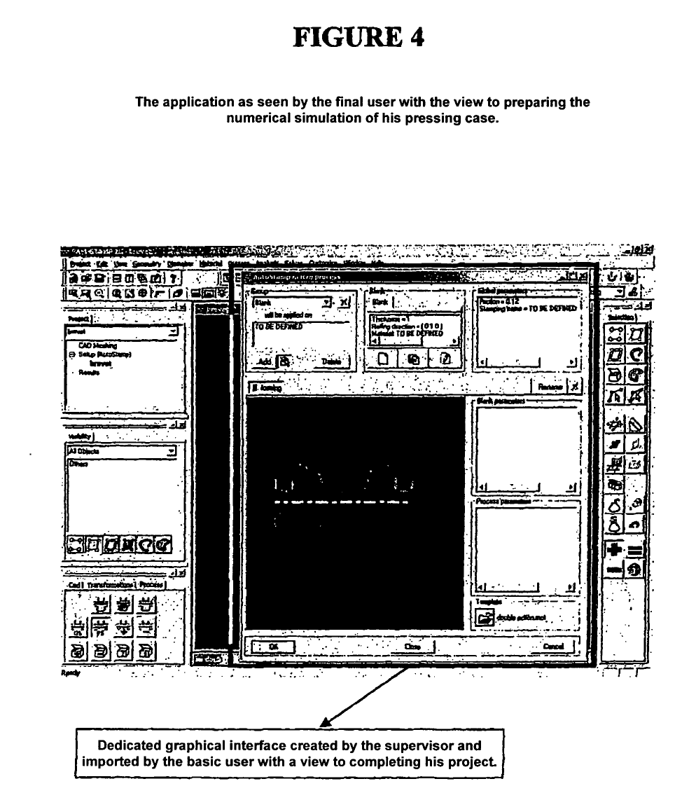

The “supervisor” is the person who creates the graphical interface representing the macrocommand, the steps, the diagram of the process, the groups of tools, the default attributes of the process and the attributes which will be requested of the final user (as shown in FIG. 3). The “final user” is the person who uses the macrocommand defined by the supervisor, giving information on the following parameters (as depicted in FIG. 4): link between the groups and the mesh objects, parameters that can be modified for each pressing project (clamping force, pressing speed, friction, etc). The “group” is a specific type of object: blank, blank holder, die, punch, etc. A group is defined by its representation in the diagram and the kinds of specific attributes directly accessible in the context of the groups. From the point of view of the supervisor, a group corresponds to an object (a component of the press) seen by the final user. The attribute is the value corresponding to a property of a group (and therefore to objects). This may be a friction, a direction, a 2D curve, etc. A step is a period of time during which each object has only one kind of kinematics: movement, force. The complete simulation process must be divided into various steps, in accordance with the behaviour of each group. Each group is active, or non-active, during each step. If a group is not active during a step, its entities (nodes, elements, 3D curves) will not be taken into account by the solver during the processing of this step. A “parameter” is a value which is common to various groups and/or which can be demanded of the user when he wishes to apply the macrocommand. This may be a floating value (friction, thickness), a direction, a property of material, an integer value (level of fineness, number of points), a 2D curve.

The macrocommand must be created by a user called the supervisor within the application. The supervisor does not need to load the project. When a user loads a preprocessed module of a project, he needs to prepare the objects and meshes necessary for the process. He then accesses a button on the macrocommand tool bar, chooses the macrocommand that he wishes to execute, sets the “final user parameters” offered by the corresponding dialogue box and clicks on the “apply” button. The steps and the attributes of the objects will then be allocated automatically to the objects. The processing of the project can be started immediately.

Certain macrocommands, such as the conventional processes (single- and double-action presses, etc) are supplied in advance in a macrocommand database. The users can use them directly, duplicate them and/or modify them in order to adapt them to their use.

Firstly, the macrocommand will be considered from the point of view of the supervisor. A graphics window makes it possible to manage the functions of creation, copying and deletion relating to the macrocommands. Three first boxes (“blank”, “tools” and “parameters”) contain data which will be active throughout the processing: the physical attribute of the blank, the list of groups corresponding to the tools (with the group name, colour, material and thickness) and the list of the parameters of the final users. The list of the parameters contains parameters which have two objectives: the first is, for the supervisor, to locate in an isolated place a value which will be used by one or more group attributes (for example the tool/blank friction, common to all the principal tools). This simplifies the modification of this value. The second objective is to determine which parameters will be requested of the final user. These parameters can be: properties of materials, the friction, the thickness, the direction of the pressing, the speed curve, etc.

The main box (called “steps”) makes it possible to allocate attributes to each group for each step. With regard to the buttons for managing the steps, one button per step updates the diagram, the active groups and the attributes. The supervisor can add, duplicate or remove steps. The diagram shows the relative positions of each group according to each step. Its use makes it possible to show diagrams of the steps of the process, showing the various tools, their kinematics and their state (active or not during the step).

A toolbox appears whenever the macrocommand editing window is called up in supervisor mode. This toolbox comprises four pages of the pattern of the pressing process: the “tools” page, the “blanks” page, the “behaviour” page and the “post-process” page.

The sections “blanks” and “tools” contain attributes that are common for all the steps (names of groups and colours, attributes of materials).

The pressing groups (blanks, tools, post-process, behaviour) represent the content of the steps. The groups of blanks must have a true hardware attribute.

The invention is described above by way of example. Naturally a person skilled in the art is in a position to implement various variants of the invention without for all that departing from the scope of the patent.

1-8. (canceled)

9. A method for the numerical simulation of a pressing process comprising the steps consisting of:
recording at least one meta-model consisting of a permanent collection of numerical representations of elementary constituents of pressing tools, each of the elementary constituents being defined in the form of finite elements, and comprising numerical static attributes,
recording a numerical model of deformation of a blank used in the process to be simulated,
selecting a subset of the permanent collection, for temporary recording of elementary constituents representing a particular pressing tool corresponding to a simulation in question, the subset constituting a specific collection in the form of digitized finite elements,
parameterizing the digitized finite elements of the specific collection, as well as the corresponding attributes according to characteristics of the process to be simulated,
recording numerical information representing relative movements of components of the specific collection, according to operating cycles of the pressing process to be simulated,
recalculating numerical models of deformation of the blank according to numerical information recorded on the one hand in the parameterized specific collection, the numerical model of the blank, and specific movements on the other hand, and
generating a numerical or visual representation of the deformations of the blank by the application of the recalculated numerical model.

10. A simulation method according to claim 9, wherein the selecting step comprises modifying the state of the elementary constituents that are not pertinent with regard to the selected constituents.

11. A simulation method according to claim 9, further comprising a step of loading, from an external information medium, at least part of the collection parameterizing information.

12. A simulation method according to claim 9, further comprising a step of loading, from an external information medium, the model of the blank.

13. A simulation method according to claim 9, further comprising a step of loading, from an external information medium, the numerical representation of the subset.

14. A simulation method according to claim 9, wherein the step of forming the specific collection further comprises displaying a graphical interface and recording information captured from the graphical interface.

15. A simulation method according to claim 14, wherein the step of displaying a graphical interface comprises personalizing a prerecorded interface, wherein said personalization at least partly takes account of the information coming from the prior steps of the method.

16. A simulation method according to claim 9, further comprising defining several levels of use, with one of the levels of use, supervision, requiring a common generic parameterizing defining to a major extent the pressing method concerned and the other, basic, levels of use, basic, requiring no more than partial parameterizing, complementary and specific, benefiting from the previously performed parameterizing of the supervision level.
